(19) United States
(12) Patent Application Publication
(10) Pub. No.: US 2020/0011182 A1
(43) Pub. Date: Jan. 9, 2020

(54) METHOD FOR MODIFYING A TURBINE

(71) Applicant: Siemens Aktiengesellschaft, Munich (DE)

(72) Inventors: Fathi Ahmad, Kaarst (DE); Tobias Buchal, Düsseldorf (DE); Olivier Gand, Düsseldorf (DE)

(73) Assignee: Siemens Aktiengesellschaft, Munich (DE)

(21) Appl. No.: 16/483,425

(22) PCT Filed: Feb. 5, 2018
(86) PCT No.: PCT/EP2018/052803

§ 371 Date: Aug. 4, 2019

(30) Foreign Application Priority Data
Feb. 10, 2017 (EP) 17155610.3

(51) Int. Cl. F01D 5/02; F01D 5/14

(52) U.S. Cl. CPC F01D 5/025; F01D 5/143; F05D 2270/20; F05D 2230/80; F05D 2230/64

(57) ABSTRACT

A method for modifying a turbine with rotor blade rings and guide vane rings arranged in a conical housing, in which an original rotor blade ring at a first rotor blade position is replaced by a replacement rotor blade ring at a second rotor blade position, wherein the second rotor blade position is arranged spaced apart from the first rotor blade position along a direction of extent of a rotor shaft of the turbine in the flow direction of a working medium flowing through the turbine.

### CROSS REFERENCE TO RELATED APPLICATIONS

This application is the US National Stage of International Application No. PCT/EP2018/052803 filed Feb. 5, 2018, and claims the benefit thereof. The International Application claims the benefit of European Application No. EP17155610 filed Feb. 10, 2017. All of the applications are incorporated by reference herein in their entirety.

### FIELD OF INVENTION

The invention relates to a method for modifying a turbine.

### BACKGROUND OF INVENTION

Thermal turbomachines are understood to mean machines in which a transfer of energy between a working medium (liquid or gas) and the thermal turbomachines is realized in an open space by a flow via the diversion of the kinetic energy according to the laws of fluid dynamics.

Such a thermal turbomachine, such as for example a gas turbine, may have a compressor and a turbine. The compressor is designed for compressing a gaseous working medium, while the turbine converts the internal energy of a flowing working medium into mechanical energy, which it delivers via a turbine shaft.

Thermal turbomachines have a blade arrangement which comprises the totality of the blades, for example of the turbine. Here, a distinction is made between rotor blades and guide blades. A ring of rotor blades together with the associated ring of guide blades is referred to as a stage. The blade arrangement of the turbine and/or of the compressor may have multiple stages.

The guide blades are fixedly installed in a housing of the turbine and guide the working medium at an optimum angle to the rotor blades, which are situated on rotatable shafts. The coupling of the mechanically usable energy between the thermal turbomachine and the working medium takes place via the rotor blades.

For the specification of the number of stages of the turbine, the number of the rotor blade rings is decisive: a for example five-stage turbine has five rotor blade rings. The guide blade rings are generally assigned to the preceding rotor blade ring in the case of compressors, and to the following rotor blade ring in the case of turbines.

Blades, that is to say rotor or guide blades, have a blade airfoil, a platform which is joined to the blade airfoil, and a root which is joined to the platform and has a fastening section for fastening the blades to the housing or to the rotor of the turbine.

However, adaptation of such a thermal turbomachine to changed requirements, in particular to increased power requirements, is possible only with considerable effort. In this regard, for increasing the possible maximum power, it is known from U.S. Pat. No. 5,110,256 to replace both the rotor blades of the last steam turbine stage and the associated housing by those which provide a greater flow-off surface overall. However, such a conversion is relatively cumbersome since both, namely rotor and housing, have to be converted. A further conversion is also disclosed by U.S. Pat. No. 5,494,405. Here, the reason for the conversion is the occurrence to a large extent of moisture, so that, with the conversion, a possibility for simpler removal of the moisture is created. For this purpose, the intention is for the rotor blades of the last stage of a steam turbine to be repositioned axially toward the downstream direction, in order for the installation space gained in this way to be used for enlarged drainage openings.

There is thus a need for at least demonstrating a way in which a turbine can be modified with little effort.

### SUMMARY OF INVENTION

According to the invention, for modifying a turbine having, arranged in a housing of conical form, rotor blade rings and guide blade rings, an original rotor blade ring at a first rotor blade position is replaced by a replacement rotor blade ring at a second rotor blade position, wherein, while keeping the housing, the second rotor blade position is arranged spaced apart from the first rotor blade position along a direction of extent of a rotor shaft of the turbine in the flow direction of a working medium flowing through the turbine. In this way, it is possible in a surprisingly simple manner to modify a turbine in order to adapt said turbine to increased power requirements. At the same time, the Mach number of the working medium can thereby be reduced.

Furthermore, the replacement rotor blade ring has a larger outer diameter than the original rotor blade ring. The use thereof is realized without changing the housing, that is to say with the conical opening angle maintained. This is possible simply because, owing to the housing conicity and the rotor blades that are then arranged further downstream, the distance between the rotor axis and an inner diameter of the housing is enlarged in comparison with the distance at the first rotor blade position. Adaptation to a pre-existing, enlarged inner diameter of the housing is thereby realized, with the result that a particularly energy-efficient turbine is provided in a simple manner.

Use is advantageously made of a separate component as a positioning element. In this way, it is possible for the position of the replacement rotor blade ring to be fixed without the rotor disk of the replacement rotor blade ring being modified.

Advantageously, a positioning element designed in the form of a spacer or ring is arranged in the rotor shaft for the purpose of fixing the replacement rotor blade ring at the second rotor blade position. It is thus possible in a particularly simple manner for the replacement rotor blade ring to be fixed at the second rotor blade position such that, with the replacement rotor blades, the axial position of the inner end of the blade airfoil, in relation to the axial position of the blade root can be kept the same as for the original rotor blades. This reduces the effort in terms of construction for determining the shape of the replacement rotor blades.

Use is advantageously made of a positioning element designed in the form of a spacer or ring. It is thus possible for use to be made of a positioning element which is particularly simple to produce.

The positioning element is advantageously formed integrally on the replacement rotor blade ring. Fitting of additional components is thereby dispensed with.

Advantageously, the positioning element is formed by an extension on a balcony of a root of a replacement rotor blade of the replacement rotor blade ring. The blade roots of the replacement rotor blades are axially changed in detail in that said roots are lengthened on their upstream side and shortened on their downstream side. The rotor disk, in which the rotor blades are held in a conventional manner, can accordingly continue to be used unchanged without a spacer being inserted in the rotor shaft. Consequently, the replacement rotor blades are then arranged in the groove of the rotor disk such that the blade airfoil thereof is arranged further downstream axially than the blade airfoil of the original rotor blades was. In order to avoid an enlarged radial gap at the blade tips of the replacement rotor blades, the blade airfoils thereof can be lengthened at the tip side by deposition welding or other suitable additive methods. It is thus possible for the positioning element to be formed by a particularly simple modification of a rotor blade.

Advantageously, for the purpose of fixing the replacement rotor blade ring at the second rotor blade position, a shortening (in the axial direction on the downstream side) of a root of a replacement rotor blade of the replacement rotor blade ring is realized. It is thus possible, by a particularly simple modification of a root of a rotor blade, for the position of the rotor blade to be determined anew if for example the intention is for said blade to be positioned at a stop situated downstream.

Also part of the invention are a turbine modified in such a way and a rotor blade ring for such a turbine and also a replacement rotor blade for such a replacement rotor blade ring.

### BRIEF DESCRIPTION OF THE DRAWINGS

An embodiment of the method according to the invention will be discussed below on the basis of the appended schematic drawings, in which:

FIG. 1 shows a schematic illustration of a section of a turbine,

FIG. 2 shows a schematic illustration of a modification of the turbine shown in FIG. 1,

FIG. 3 shows a detail of the modified turbine.

### DETAILED DESCRIPTION OF INVENTION

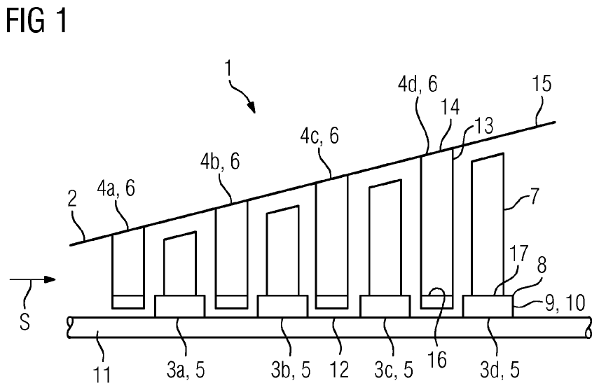

Reference will firstly be made to FIG. 1.

The illustration shows a turbine 1, which is designed in the form of an axial turbine 1 in the present exemplary embodiment.

In the present exemplary embodiment, the turbine 1 is of four-stage form, that is to say the turbine 1 has a blade arrangement with four rotor blade rings 3a, 3b, 3c, 3d and three guide blade rings 4a, 4b, 4c, 4d.

The rotor blade rings 3a, 3b, 3c, 3d each have a plurality of rotor blades 5, while the guide blade rings 4a, 4b, 4c, 4d each have a plurality of guide blades 6.

The rotor blade rings 3a, 3b, 3c, 3d and the guide blade rings 4a, 4b, 4c, 4d are arranged alternately one behind the other in a housing 2 in the flow direction of a working medium which flows through the turbine 1, starting with the guide blade ring 4a, followed by the rotor blade ring 3a, etc. Here, the housing 2 is of conical form and widens in the flow direction S of the working medium.

The rotor blades 5 each have a rotor blade airfoil 7, a platform 8 which is joined to the blade airfoil, and a root 9 which is joined to the platform 8 and has a rotor blade fastening section 10.

By way of the respective rotor blade fastening sections 10, the rotor blades 5 are fastened to a rotor shaft 11 of the turbine 1 by being inserted into respective groove-like receiving parts 12 of the rotor shaft 11.

The guide blades 6 each have a guide blade airfoil 3a, 3b, 3c, 3d and, at their radially outward ends, a guide blade fastening section 14, by way of which the guide blades 6 are fastened to a ring-like guide blade carrier 15. The guide blades 6 each have a seal element 16 at their radially inward ends, which is in each case arranged between rotor blade fastening sections 10 of two adjacent rotor blades 5. For the purpose of improving sealing between the rotor blades 5 and guide blades 6, the rotor blade fastening sections 10 have respective balconies 17, which are formed as an extension on the respective platform 8 and extend in, or counter to, the flow direction.

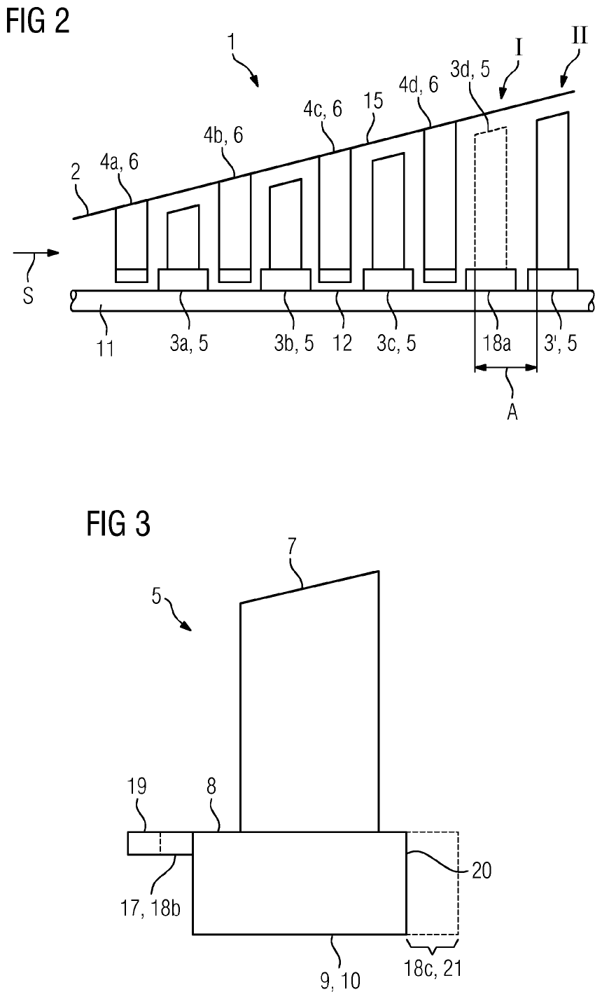

Reference will now additionally be made to FIG. 2 in order to discuss an exemplary embodiment of a method for modifying the turbine 1.

In order to modify the turbine 1, for example in order to adapt it to increased power requirements, an original rotor blade ring 3a, 3b, 3c, 3d at a first rotor blade position I is removed. In the present exemplary embodiment, said rotor blade ring is the last rotor blade ring 3d in the flow direction S at the rotor blade position I.

A replacement rotor blade ring 3′ is then fitted at a second rotor blade position II. In other words, the replacement rotor blade ring 3′ at the second rotor blade position II replaces the original rotor blade ring 3d at the first rotor blade position I. Here, the replacement rotor blade ring 3′ consists of a plurality of replacement rotor blades 5′.

Here, the second rotor blade position II is arranged spaced apart from the first rotor blade position I along a direction of extent of the rotor shaft 11 of the thermal turbomachine 1 in the flow direction of the working medium, wherein the distance A is dimensioned such that the replacement rotor blade ring 3′ is still situated within the housing 2. In the present exemplary embodiment, the distance A is between 3 mm and 15 mm, for example 10 mm.

In deviation from the present exemplary embodiment, provision may also be made for the second rotor blade ring 3b, for example, to be displaced by the distance A. In this case, the third rotor blade ring 3c, the fourth rotor blade ring 3d and the third guide blade ring 4c, which is arranged between the third rotor blade ring 3c and the fourth rotor blade ring 3d, are displaced in the flow direction S by the distance A.

The replacement rotor blade ring 3′ has a larger outer diameter than the original rotor blade ring 3d, this being matched to an inner diameter of the housing 2 at the second rotor blade position II.

A positioning element 18a is provided for the purpose of fixing the replacement rotor blade ring 3′ at the second rotor blade position II. In the present exemplary embodiment, the positioning element 18a is designed in the form of a spacer or ring and has been pushed onto the rotor shaft 11 prior to the fitting of the replacement rotor blade ring 3′.

A second exemplary embodiment of the positioning element 18b will now be discussed with reference to FIG. 3.

As per the second exemplary embodiment, the positioning element 18b is formed integrally on the replacement rotor blade ring 3′, for example in the form of an extension 19 of the balcony 17. Alternatively or additionally, provision may also be made for the positioning element 18b to be formed by a rear contact surface 20, which is forwardly displaced by way of a shortening 21 of the root 9 counter to the flow direction S. In other words, material is removed from the rear side of the root 8 so that, owing to the shortened root 8, the replacement rotor blade ring 3′ can be displaced in the flow direction S.

It is thus possible for a turbine 1 to be modified with little effort.

Even though the invention has been illustrated and described in more detail by way of the embodiment, the invention is not restricted by the examples disclosed, and other variations may be derived therefrom by a person skilled in the art without departing from the scope of protection of the invention.

1. A method for modifying a turbine having, arranged in a housing of conical form, rotor blade rings and guide blade rings, the method comprising:
replacing an original rotor blade ring at a first rotor blade position by a replacement rotor blade ring at a second rotor blade position,
while keeping the housing, arranging the second rotor blade position spaced apart from the first rotor blade position along a direction of extent of a rotor shaft of the turbine in the flow direction of a working medium flowing through the turbine,
wherein the replacement rotor blade ring has a larger outer diameter than the original rotor blade ring.

2. The method as claimed in claim 1, further comprising:
using a separate component as a positioning element.

3. The method as claimed in claim 1, further comprising:
arranging a positioning element designed in the form of a spacer or ring in the rotor shaft for the purpose of fixing the replacement rotor blade ring at the second rotor blade position.

4. The method as claimed in claim 1,
wherein a positioning element is formed integrally on the replacement rotor blade ring.

5. The method as claimed in claim 4,
wherein the positioning element is formed by an extension on a balcony of a root of a replacement rotor blade of the replacement rotor blade ring.

6. The method as claimed in claim 4,
wherein, for the purpose of fixing the replacement rotor blade ring at the second rotor blade position, a shortening of a root of a replacement rotor blade of the replacement rotor blade ring is realized.
